(19) United States
(12) Patent Application Publication
(10) Pub. No.: US 2006/0095773 A1
(43) Pub. Date: May 4, 2006

(54) Authentication system, light emitting device, authentication device and authentication method

(76) Inventors: Hideo Itoh, Tokyo (JP); Takuichi Nishimura, Tokyo (JP); Yoshiyuki Nakamura, Tokyo (JP); Hideyuki Nakashima, Tokyo (JP)

Correspondence Address: WENDEROTH, LIND & PONACK, L.L.P., 2033 K STREET N. W., SUITE 800, WASHINGTON, DC, 20006-1021, US

(21) Appl. No.: 10/529,882

(22) PCT Filed: Oct. 2, 2003
(86) PCT No.: PCT/JP03/12637

§ 371 Date: Sep. 27, 2005

(30) Foreign Application Priority Data
Oct. 3, 2002 (JP) 2002-290818
Aug. 19, 2003 (JP) 2003-295077

(51) Int. Cl. H04L 9/00

(52) U.S. Cl. 713/176

(57) ABSTRACT

The invention provides a new authentication system which is capable of not being deceived by copied images and excellent in authentication accuracy and convenience. An image with built-in authentication information to be used for authentication is emitted by an emission angle-dependent light emitting device while being diffracted at a specified angle. An emission angle-dependent light for detector 22 collects a diffracted light, and a control device 23 converts it into an image in the form of an electrical signal. The image in the form of an electrical signal is used for authenticating.

### TECHNICAL FIELD

The present invention relates to an authentication system, a light emitting device, an authentication device and an authentication method, which perform authenticating by diffracting a displayed image.

### BACKGROUND TECHNIQUE

There are various electronic devices which require confirmation of a proper user by personal authentication for device operation, manipulation, etc., and authentication methods using images are widely used for the reasons that ordinary circuits can be used and such.

Some of these authentication methods are as follows:

(1) Color information used as authentication information is preliminary inserted in a specific position of an image used for authentication, and upon authentication, it is confirmed whether the color information at the specific position is the predetermined information (e.g. patent reference 1).

(2) A pigment whose color changes when irradiated with a laser beam is preliminary coated on a card, and upon authentication, the card owned by a user is irradiated with a laser beam and its color change is automatically detected (e.g. patent reference 2).

(3) An eye of a user is photographed, and it is determined whether the photographed image is a true user (e.g. patent references 3, 4 and 5). There is also a method which uses a user fingerprint pattern (e.g. patent reference 6).

[Patent Reference 1]

Japanese Patent Application Laid-open No. H11-145952

[Patent Reference 2]

Japanese Patent Application Laid-open No. 2002-074474

[Patent Reference 3]

Japanese Patent Application Laid-open No. 2002-218049

[Patent Reference 4]

Japanese Patent Application Laid-open No. 2000-307715 [Patent Reference 5]

Japanese Patent Application Laid-open No. H11-146057

[Patent Reference 6]

Japanese Patent Application Laid-open No. S63-156290

### DISCLOSURE OF THE INVENTION

According to the above method (1), in the case where the image used for the authentication is illegally copied (electrically in an information processing device or on paper using a copier) and used, the authentication device cannot detect such fraud.

The above method (2) has a merit of convenience, but also has a problem that the card no longer can be used for the authentication if the pigment applied to the card undergoes aged deterioration.

The above method (3) has a high authentication accuracy, but also has a problem that physical characteristics must be registered in an information processing device for each person to be authenticated, which makes the data registration and management complex.

As described above, the image-use authentication methods have both merits and demerits with regard to the authentication accuracy and convenience. Thus, it is desired that the methods be improved.

To solve the above problems, a first aspect of the present invention provides an authentication system comprising a light emitting device having display means for displaying an image in which authentication information is incorporated and first optical system means for diffracting light of the displayed image at a predetermined angle for each pixel, and an authentication device having second optical system means for collecting the light of the image diffracted by the light emitting device, photoelectric converting means which carries out photoelectric conversion of the collected image and control means which carries out authentication using the photoelectrically concerted image.

According to a second aspect of the invention, in the authentication system, the display means and the first optical system means are arranged so that in the image displayed by the display means, the image corresponding to the authentication information is diffracted and the image other than authentication information is emitted in a direction substantially perpendicular to a display screen of the display means.

According to a third aspect of the invention, n the authentication system, the image is displayed from the light emitting device in response to an inquiry signal from the authentication device.

According to a fourth aspect of the invention, in the authentication system, the first optical system means and the second optical system means are lens arrays which utilize one dimensional light distribution.

According to a fifth aspect of the invention, in the authentication system, the first optical system means and the second optical system means are lens arrays which utilize two dimensional light distribution.

According to a sixth aspect of the invention, in the authentication system, the image is a hologram pattern.

According to a seventh aspect of the invention, in the authentication system, the image is a graphic pattern which does not exhibit hologram effect.

According to an eighth aspect of the invention, in the authentication system, the first optical system means is a lens array comprising a plurality of lenses, and gaps are provided between the lenses.

A ninth aspect of the invention provides a light emitting device comprising display means for displaying an image in which authentication information is incorporated, and optical system means for diffracting light of the displayed image at a predetermined angle for each pixel.

According to a tenth aspect of the invention, in the light emitting device, the display means and the optical system means are arranged so that in the image displayed by the display means, the image corresponding to the authentication information is diffracted and the image other than authentication information is emitted in a direction substantially perpendicular to a display screen of the display means.

According to an eleventh aspect of the invention, in the light emitting device, the image is displayed from the display means in response to an inquiry signal from an outside device.

According to a twelfth aspect of the invention, in the light emitting device, the optical system means is a lens array which utilizes one dimensional light distribution.

According to a thirteenth aspect of the invention, in the light emitting device, the optical system means is a lens array which utilizes two dimensional light distribution.

According to a fourteenth of the invention, in the light emitting device, the image is a hologram pattern.

According to a fifteenth aspect of the invention, in the light emitting device, the image is a graphic pattern which does not exhibit hologram effect.

According to a sixteenth aspect of the invention, in the light emitting device, the optical system means is a lens array comprising a plurality of lenses, and gaps are provided between the lenses.

A seventeenth aspect of the invention provides an authentication device comprising optical system means for collecting light of an image diffracted at a predetermined angle by an outside device, photoelectric converting means which carries out photoelectric conversion of the collected image, and control leans which carries out authentication using the converted image.

According to an eighteenth aspect of the invention, in the authentication device, the image corresponding to the authentication information is diffracted and the image other than the authentication information are not diffracted.

According to a nineteenth aspect of the invention, in the authentication device, an inquiry is made for requesting an outside device to output the image.

According to a twentieth aspect of the invention, in the authentication device, the optical system means is a lens array which utilizes one dimensional light distribution.

According to a twenty-first aspect of the invention, in the authentication device, the optical system means is a lens array which utilizes two dimensional light distribution.

According to a twenty-second aspect of the invention, in the authentication device, the image is a hologram pattern.

According to a twenty-third aspect of the invention, in the authentication device, the image is a graphic pattern which does not exhibit hologram effect.

According to a twenty-fourth aspect of the invention, in the authentication device, the outside device has an optical system means for diffracting light, said optical system means is a lens array comprising a plurality of lenses, and gaps provided between the lenses.

A twenty-fifth aspect of the invention provides an authentication method comprising the steps of displaying, from display means, an image in which authentication information is incorporated, diffracting light of the displayed image at a predetermined angle for each pixel by first optical system means, collecting, by second optical system means, the light of the image diffracted by the first optical system means, carrying out photoelectric conversion of the collected image by photoelectric converting means, and carrying out authentication by control means using the converted image.

According to a twenty-sixth aspect of the invention, in the authentication method, the display means and the first optical system means are arranged such that in an image displayed by the display means, the image corresponding to the authentication information is diffracted and the image other than authentication information is emitted in a direction substantially perpendicular to a display screen of the display means.

According to a twenty-seventh aspect of the invention, in the authentication method, the image is displayed from the display means in response to an inquiry.

According to a twenty-eighth aspect of the invention, in the authentication method, the first optical system means and the second optical system means are lens arrays which utilize one dimensional light distribution.

According to a twenty-ninth aspect of the invention, in the authentication method, the first optical system means and the second optical system means are lens arrays which utilize two dimensional light distribution.

According to a thirtieth aspect of the invention, in the authentication method, the image is a hologram pattern.

According to a thirty-first aspect of the invention, in the authentication method, the image is a graphic pattern which does not exhibit hologram effect.

According to a thirty-second aspect of the invention, in the authentication method, the first optical system means is a lens array comprising a plurality of lenses, and gaps are provided between the lenses.

According to the authentication system of the first aspect, since the light of the image in which the authentication information is incorporated is diffracted, the authentication will not be misconducted even if an illegally copied image is given to the authentication device. Thus, the authentication can be carried out with much balanced accuracy and convenience. That is, in contrast with the conventional authentication system using only a two dimensional image, the invention employs an authentication system of a pattern having image information with angle distribution or having information utilizing its time variation and thus can realize the authentication with a high accuracy and more strengthened security.

According to the authentication system of the second aspect, in addition to the effect of the first authentication system, it is possible to show the image other than the authentication information from the display means to a person who watches the display means.

According to the authentication system of the third aspect, in addition to the effect of the first authentication system, because the light emitting device can output the image upon the inquiry, two-way communication can be carried out, and power consumption can be reduced

According to the authentication system of the fourth aspect, in addition to the effect of the first authentication system, because the first optical system means and the second optical system means are lens arrays which utilize one dimensional light distribution, the structure of the optical system can be simplified.

According to the authentication system of the fifth aspect, in addition to the effect of the first authentication system, because the first optical system means and the second optical system means are lens arrays which utilize two dimensional light distribution, security is ensured more reliably.

According to the authentication system of the sixth aspect, in addition to the effect of the first authentication system, because the image is a hologram pattern, it is possible to give a three-dimensional effect to the image and inform a person who watches the image about the image contents.

According to the authentication system of the seventh aspect, in addition to the effect of the first authentication system, because the image is a graphic pattern which does not exhibit hologram effect, it is possible to conceal the image contents from a person who watches the image.

According to the authentication system of the eighth aspect, in addition to the effect of the first authentication system, because the gaps are provided between the lenses, the flexibility of disposition of the lenses is enhanced.

According to the light emitting device of the ninth aspect, the effect of the authentication system of the first aspect can be obtained.

According to the light emitting device of the tenth aspect, the effect of the authentication system of the second aspect can be obtained.

According to the light emitting device of the eleventh aspect, the effect of the authentication system of the third aspect can be obtained.

According to the light emitting device of the twelfth aspect, the effect of the authentication system of the fourth aspect can be obtained.

According to the light emitting device of the thirteenth aspect, the effect of the authentication system of the fifth aspect can be obtained.

According to the light emitting device of the fourteenth aspect, the effect of the authentication system of the sixth aspect can be obtained.

According to the light emitting device of the fifteenth aspect, the effect of the authentication system of the seventh aspect can be obtained.

According to the light emitting device of the sixteenth aspect, the effect of the authentication system of the eighth aspect can be obtained.

Further, according to the authentication device of the seventeenth aspect, the effect of the authentication system of the first aspect can be obtained.

According to the authentication device of the eighteenth aspect, the effect of the authentication system of the second aspect can be obtained.

According to the authentication device of the nineteenth aspect, the effect of the authentication system of the third aspect can be obtained.

According to the authentication device of the twentieth aspect, the effect of the authentication system of the fourth aspect can be obtained.

According to the authentication device of the twenty-first aspect, the effect of the authentication system of the fifth aspect can be obtained.

According to the authentication device of the twenty-second aspect, the effect of the authentication system of the sixth aspect can be obtained.

According to the authentication device of the twenty-third aspect, the effect of the authentication system of the seventh aspect can be obtained.

According to the authentication device of the twenty-fourth aspect, the effect of the authentication system of the eighth aspect can be obtained.

Furthermore, according to the authentication method of the twenty-fifth aspect, the effect of the authentication system of the first aspect can be obtained.

According to the authentication method of the twenty-sixth aspect, the effect of the authentication system of the second aspect can be obtained.

According to the authentication method of the twenty-seventh aspect, the effect of the authentication system of the third aspect can be obtained.

According to the authentication method of the twenty-eighth aspect, the effect of the authentication system of the fourth aspect can be obtained.

According to the authentication method of the twenty-ninth aspect, the effect of the authentication system of the fifth aspect can be obtained.

According to the authentication method of the thirtieth aspect, the effect of the authentication system of the sixth aspect can be obtained.

According to the authentication method of the thirty-first aspect, the effect of the authentication system of the seventh aspect can be obtained.

According to the authentication method of the thirty-second aspect, the effect of the authentication system of the eighth aspect can be obtained.

### BRIEF DESCRIPTION OF THE DRAWINGS

FIG. 1 is a block diagram showing one example of a structure of an embodiment of the present invention;

FIG. 2 is a sectional view showing a structure of a emission angle-dependent light emitting device;

FIG. 3 is a partial sectional view showing the structure of the emission angle-dependent light emitting device;

FIGS. 4(A) to (C) are schematic perspective views of examples of optical elements that can be used as a leas array;

FIG. 5 is a block diagram showing a photoreceiver device array of a emission angle-dependent light detector;

FIG. 6 is a block diagram showing another shape of the emission angle-dependent light detector;

FIG. 7(A) is a schematic perspective view showing a shape of a photodetector of the photoreceiver array, and FIG. 7(B) is a schematic block diagram showing another configuration of the photodetector of the photoreceiver array;

FIG. 8 is a block diagram showing another structure of the emission angle-dependent light detector;

FIG. 9 is a block diagram showing another structure of the emission angle-dependent light detector;

FIG. 10 is a block diagram showing another structure of the emission angle-dependent light detector;

FIG. 11 is a plan view showing one example of outward appearance of the emission angle-dependent light detector;

FIG. 12 is a block diagram showing a circuit structure of a liquid crystal panel;

FIG. 13 is a schematic block diagram showing a structure of a liquid crystal control integrated circuit;

FIG. 14 is a sectional view showing a mount example of the liquid crystal control integrated circuit;

FIG. 15 is a sectional view showing another mount example of the liquid crystal control integrated circuit;

FIG. 16 is a schematic block diagram showing a structure of an optical waveguide of the liquid crystal control integrated circuit;

FIG. 17 is a schematic block diagram showing a structure of another optical waveguide of the liquid crystal control integrated circuit;

FIG. 18 is a schematic block diagram showing a structure of another optical waveguide of the liquid crystal control integrated circuit;

FIG. 19 is a sectional view showing one example of a liquid crystal driving TFT;

FIG. 20 is a sectional view showing one example of a photoreceiver device of an MSM structure that can be used as a photoreceiving element;

FIG. 21 is a flowchart showing processing procedure of the authentication device;

FIG. 22 is a flowchart showing processing procedure of the emission angle-dependent light emitting device;

FIG. 23 is a block diagram showing another structure of the emission angle-dependent light emitting device; and

FIG. 24 is a block diagram showing another structure of the emission angle-dependent light emitting device.

### BEST MODE FOR CARRYING OUT THE INVENTION

An embodiment of the present invention having the above-described features will be explained in detail with reference to the drawings.

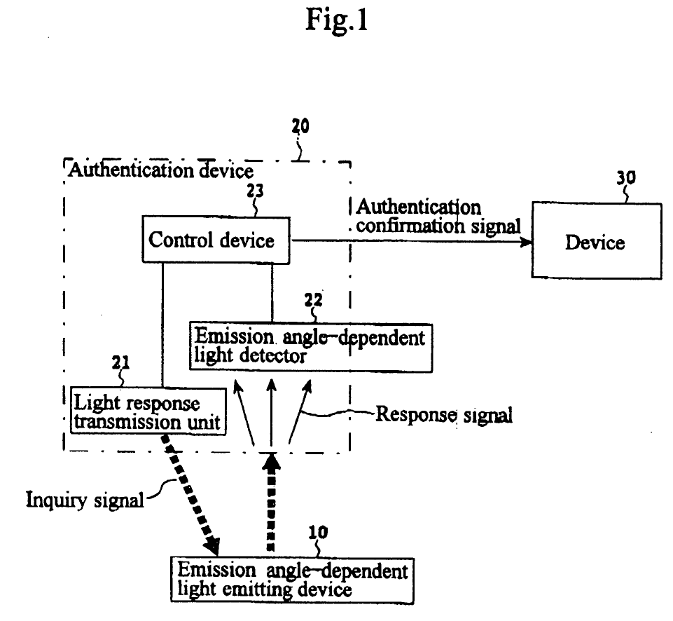

FIG. 1 shows one embodiment of an authentication system to which the present invention is applied.

In FIG. 1, reference symbol 10 represents a emission angle-dependent light emitting device which emits light with display means and a first optical system means. The emission angle-dependent light emitting device emits an authentication image in which authentication information is contained with diffracted light, and displays and outputs the same. The emission angle-dependent light emitting device can also be called an authentication information outputting device. Optical data of specific wavelengths (luminance values of three primary colors for example) is used as the authentication information.

Reference symbol 20 represents an authentication device. The authentication device includes a emission angle-dependent light detector 22 which functions as the second optical system means and the photoelectric converting means, a control device 23 which functions as the control means, and a light response transmission unit 21.

The light response transmission unit 21 requests (demands) an authentication image in which the authentication information is built in. Known optical communication devices may be used as the light response transmission unit 21.

The emission angle-dependent light detector 22 receives emission angle-dependent light (authentication image with the authentication information) which is output from the emission angle-dependent light emitting device 10, and converts the image into electric signals (image data, hereinafter).

Various information processing devices capable of executing programs of a CPU or a personal computer and the like may be used as the control device 23. Using an authentication program, the control device 23 compares image data detected by the emission angle-dependent light detector 22 and image data which was previously stored in a memory with each other, and when it is determined that they match with each other, the control device 23 makes authentication, i.e., confirm that the applicant is a proper user. The result of determination is output on one of various devices 30 which require security such as a personal computer (PC) or a door, as an authentication confirmation signal. When the authentication confirmation signal indicates that the authentication has been made, the device 30 carries out information processing for permitting the user to use.

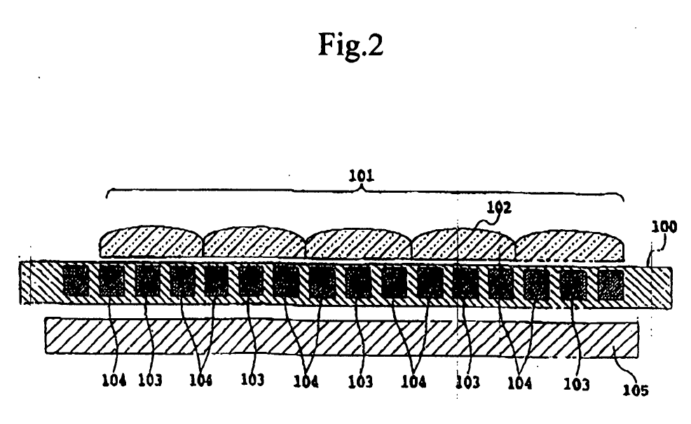

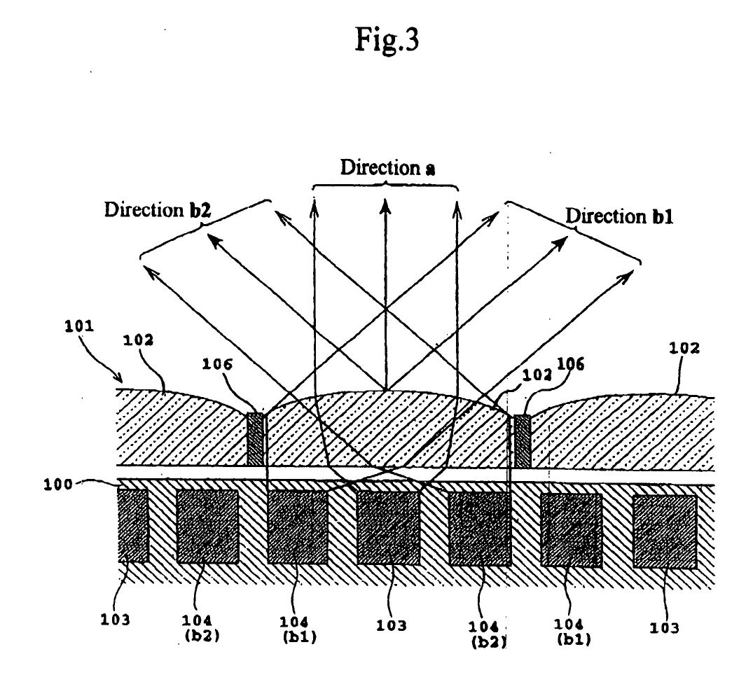

The emission angle-dependent light emitting device 10 will be explained more concretely. In FIGS. 2 and 3 which show one example of the structure, reference symbol 100 represents a liquid crystal panel, reference symbol 105 represents a rear illumination which illuminates the liquid crystal panel 100 from behind. The liquid crystal panel 100 and the rear illumination 105 are generally called liquid crystal display.

Reference symbol 101 represents a lens array as the optical system means disposed on the side of the display screen of the liquid crystal panel 100, i.e., on the side where a user sees the display. The lens array 101 diffracts light which passes through the liquid crystal panel 100 in the illumination light of the rear illumination 105.

Reference symbols 103 and 104 represent pixels of the crystal panel 100. If the pixels 103 and 104 open and close, the illumination light passes or is blocked. Light output from a specific pixel position enters a pixel on a specific position of the emission angle-dependent light detector 22 as will be described hereinafter.

The pixel position will be explained. First, pixels 103 are disposed directly below centers of lenses 102 of the lens array 101. The pixel 103 displays an image pattern of a character or picture for a person to observe from the front. That is, the pixel 103 emits the image pattern in a direction a substantially perpendicular to the display screen (see FIG. 3). Pixels 104 are disposed directly below peripheries of the 102 of the lens array 101, i.e., below positions away from centers of the leases 102. The pixel 104 displays an image pattern having different observation angles. A focal length of each lenses 102 and a distance from the liquid crystal panel 100 are adjusted such that the focus point is at each pixel.

As shown in FIG. 3, pixels 104 directly below left and right peripheries of the lenses 102 comprise pixels b1 for emitting light in a direction b1 and pixels b2 for emitting light in a direction b2. Light shielding layers 106 are also disposed between the lenses 102 of the lens array 101 so that even if the emission light of the pixels b1 and b2 enters the adjacent lenses 102 not the lenses 102 located directly above, the light is not emitted to a direction other than the directions b1 and b2. When light, e.g., stray light in a direction other than most desired direction from the pixel is to be used, the light shielding layer 106 way be omitted.

Since the pixels b1 and b2 are placed away from the centers from the lenses 102 in this manner, light emitted therefrom is refracted in the directions b1 and b2. With this, the emission light is diffracted at different angles, and the emission angle-dependent light emitting device 10 is a liquid crystal display device capable of emitting different light depending on the angle.

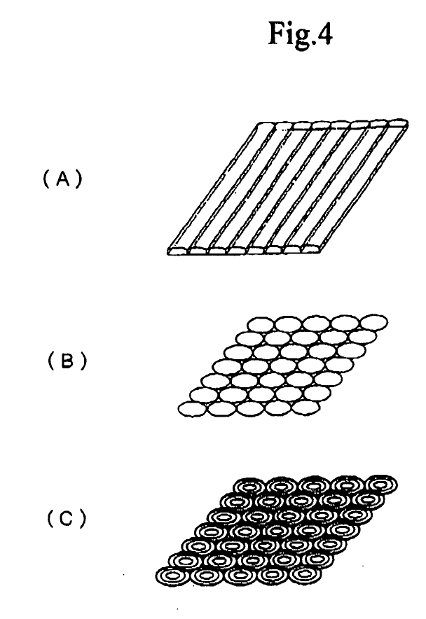

As the lens array 101, it is possible to use the following lens arrays, i.e., a cylindrical lens array in which a plurality of cylindrical lenses flat on one side and convex on the other are continuously disposed as shown in FIG. 4(A), a lens array in which a plurality of circular lenses are disposed on a flat surface as shown in FIG. 4(B), and a Fresnel lens array in which a plurality of Fresnel lenses are disposed on a flat surface as shown in FIG. 4(C). In each of the lens arrays, the lenses and the liquid crystal pixels are positioned as described above.

The emission angle-dependent light detector 22 of the authentication device 20 will be explained more concretely next. The emission angle-dependent light detector 22 requires a circuit for receiving a light emitting pattern, i.e., image pattern having angle distribution. A photoreceiver array comprising a plurality of photoreceivers having directivity may be used in this circuit.

When light emitted in different angles from the emission angle-dependent light emitting device 10 is distributed along one dimension using a cylindrical lens or the like, the photoreceivers are disposed one dimensionally, i.e., in a single line. When the light emitted in different directions is distributed in two dimensions, tie photoreceivers are disposed in two dimensions, i.e. a plurality of lines. Even if the emission light is distributed two dimensionally, if only one dimensional distribution is used for authentication, the photoreceivers may be disposed one-dimensionally.

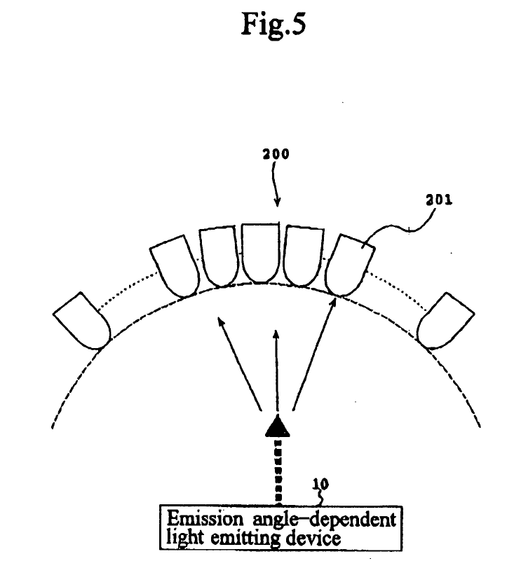

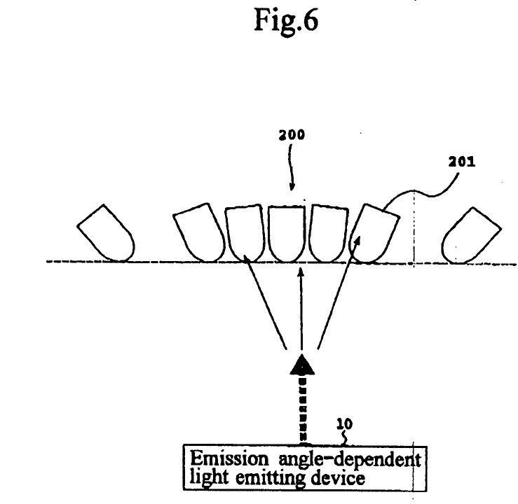

FIGS. 5 and 6 show one example of one dimensional disposition. In the case of one dimensional disposition, photoreceivers 201 of a photoreceiver array 200 may be disposed in a form of arc as shown in FIG. 5, and if the photoreceivers 201 do not interfere with each other, the photoreceivers 201 may be disposed straightly as shown in FIG. 6. Gaps may be provided between the photoreceivers 201. If the photoreceivers 201 are disposed in this manner, the photoreceiver array 200 itself also has directivity.

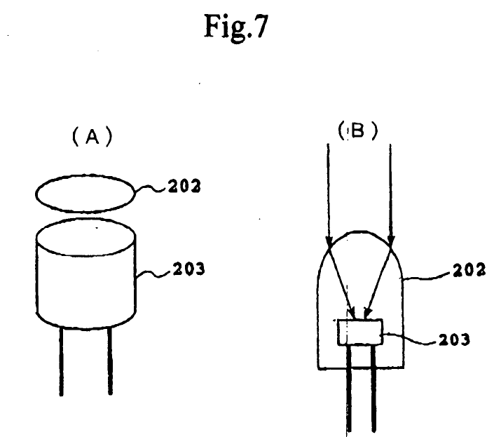

Examples of the photoreceivers 201 having directivity are a photodetector 203 having collimate lens 202 as shown in FIG. 7(A), and a photodetector 203 in which the collimate lens 202 is integrally molded as shown in FIG. 7(B).

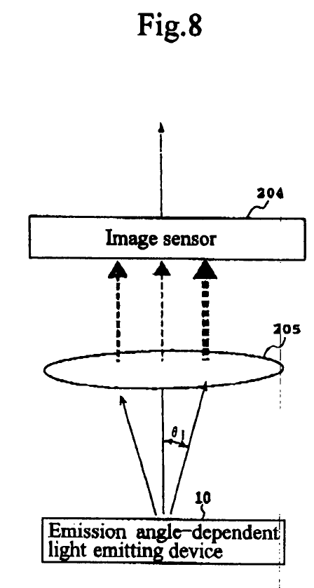

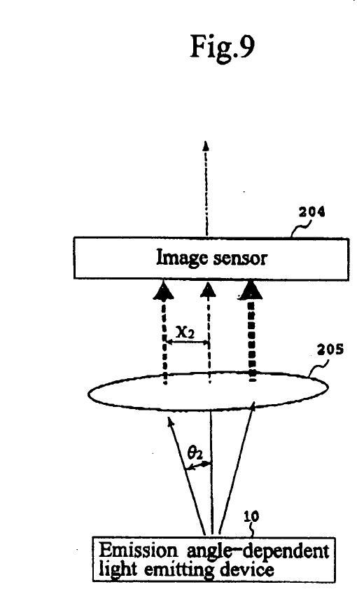

FIGS. 8 to 10 show another example of the emission angle-dependent light detector 22. In FIGS. 8 and 9, an image sensor 204 is disposed in the near the focus position using an optical system comprising a spherical convex lens 205. According to this example, a pattern similar to that described above can be obtained. However, since a complete spherical convex lens is not f-θ lens, a patterns are displayed superposed on the shooting surface. But this does not deteriorate the authentication performance. If authentication is confirmed using an angle dependency strength pattern including the image pattern at the time of registration, the authentication reliability can be enhanced.

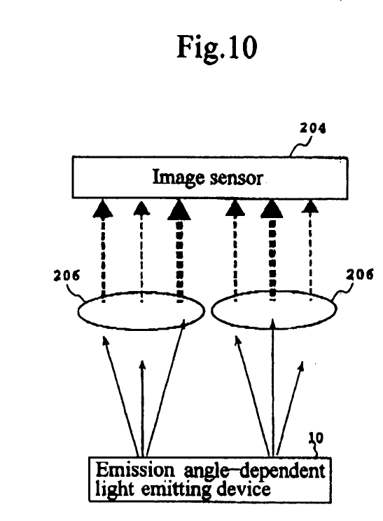

FIG. 10 shows a configuration where light is received by the image sensor 204 provided near the focus position of the spherical lens 206 using the convex lens array comprising the spherical convex lenses 206 as optical system. In the example shown in FIG. 9, a total sum of emission light strength from all pixels is received through one spherical convex lens 205, but in the case of the example shown in FIG. 10, the total sum is received through two spherical lenses 206. The number of lenses of the convex lens array need not be the same as the number of lenses of the lens array 101 in the emission angle-dependent light emitting device 10; it is sufficient that some pixels be combined to receive a emission pattern.

The diameter of the lens of the convex lens array may be in such a range that positional deviation of the emission angle-dependent light emitting device 10 can be permitted, i.e., that disposition error of the lens array 101 can be permitted, and about it is for example sufficient that the diameter be at least three times the lateral disposition error.

The emission angle-dependent light emitting device 10 and the authentication device 20 respectively send and receive the emission light, i.e., image for authentication. A system may be constructed such that the sending and receiving operations can be carried out between both the devices in accordance with sending and receiving of an inquiry signal. This is carried out through the light response transmission unit 21 in FIG. 1 and a later-described photoreceiving circuit. With this, two-way communication between the emission angle-dependent light emitting device 10 and the authentication device 20 is realized. At that time, the inquiry signal is preferably an optical signal in view of concealment of secret. Of course, minimum amplitude micro wave communication may be used.

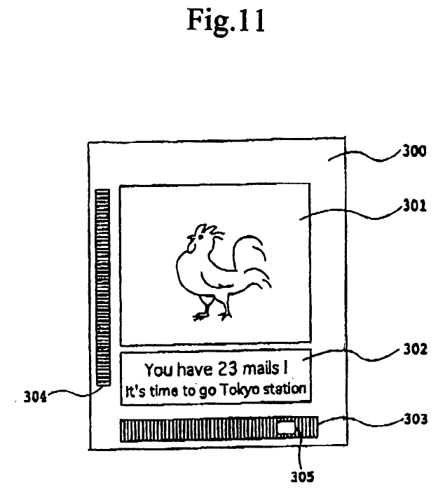

FIG. 11 shows one example of an outward appearance of the emission angle-dependent light emitting device 10.

In FIG. 11, reference symbol 300 represents a liquid crystal panel forming a front surface of the emission angle-dependent light emitting device 10.

Reference symbol 301 represents a liquid crystal display for displaying image capable of emitting light at different angles. The lens array 101 is disposed on a portion of a screen surface of the liquid crystal panel 300.

Reference symbol 302 represents another liquid crystal display 302 where the lens array 101 is not disposed as in the conventional display. In this embodiment, the liquid crystal display 302 is used for displaying characters.

Reference symbol 303 represents a liquid crystal control integrated circuit built in the emission angle-dependent light emitting device 10. The liquid crystal control integrated circuit 303 will be explained in detail later.

Reference symbol 304 represents a liquid crystal operating gate driver chip for driving the liquid crystal of the liquid crystal panel 300, and is built in the emission angle-dependent light emitting device 10. The liquid crystal operating gate driver chip 304 may be a publicly known one. For example, when it is necessary to drive the liquid crystal pixels at high speed and with high precision, the liquid crystal operating gate driver chip 304 is mounted on a glass liquid crystal panel using a chip-on-glass technique in many cases. Alternatively, when the liquid crystal operating gate driver chip 304 is integrally formed with the liquid crystal control integrated circuit chip, this is mounted as another chip in some cases. In the case of the example shown in FIG. 11, the liquid crystal operating gate driver chip 304 is mounted on the front surface of the liquid crystal panel 300 using the chip-on-glass technique. Similarly, the liquid crystal control integrated circuit 303 also may be mounted below the front surface using the chip-on-glass technique.

Reference symbol 305 represents a photoreceiving circuit which receives the inquiry signal (see FIG. 1) sent from the light response transmission unit 21 of the authentication device 20. In this embodiment, the photoreceiving circuit 305 is incorporated in the liquid crystal control integrated circuit 303, and is built up on the same chip, thereby suppressing the mounting cost of the circuit. A photodetector can be used in the photoreceiving circuit 305. It is also possible to use a light sending and receiving module such as an IrDA using the photodetector, and publicly known photoreceiving elements which adjust the luminance of the screen depending upon the peripheral brightness. In this case also, since the position of the photoreceiving circuit 305 is not prescribed, the incorporating position may appropriately be determined while taking the disposition of the liquid crystal displays 301 and 302 into consideration.

As another embodiment, the liquid crystal display itself can be utilized for the photoreceiving circuit 305. In this embodiment, the optical axis can easily be aligned for realizing the two-way communication with respect to the authentication device 20, i.e., the receiving operation corresponding to the inquiry signal and the sending operation of image as a response signal.

In this embodiment, since the photoreceiving circuit 305 is provided, the two-way communication between the emission angle-dependent light emitting device 10 and the authentication device 20 is realized.

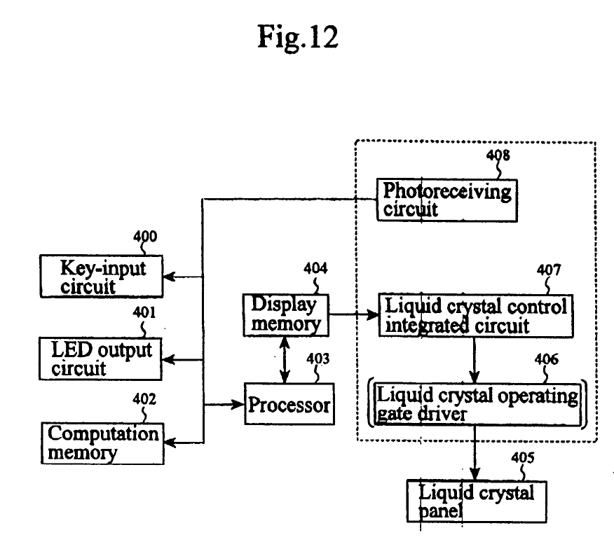

FIG. 12 shows one example of an electric circuit structure of tie liquid crystal panel 300 (405 in FIG. 12).

In FIG. 12, reference symbol 400 represents a key-input circuit for inputting information.

Reference symbol 401 represents an LED output circuit showing that the power is ON.

Reference symbol 403 represents a processor having a CPU and a ROM in which a control program is stored.

Reference symbol 402 represents a computation memory in which input data to and from the processor 403 is stored.

Reference symbol 404 represents a display memory which stores display data for displaying characters to be displayed on the liquid crystal panel 405 and images in which authentication information is incorporated. The display memory 404 stores the image data in the bitmap format, i.e., in the form of color data for each pixel.

Reference symbol 406 represents a liquid crystal operating gate driver (corresponding to 304 in FIG. 11). The liquid crystal operating gate driver 406 drives the liquid crystal elements of the liquid crystal panel 405 corresponding to pixels, based on the image data.

Reference symbol 407 represents a liquid crystal control integrated circuit which reads out the image data from the display memory 404 and sends the same to the liquid crystal operating gate driver 406.

Reference symbol 408 represents a photoreceiving circuit (corresponding to 305 in FIG. 11).

Since various well known circuits can be used as the above-described circuits, detailed explanation thereof will be omitted.

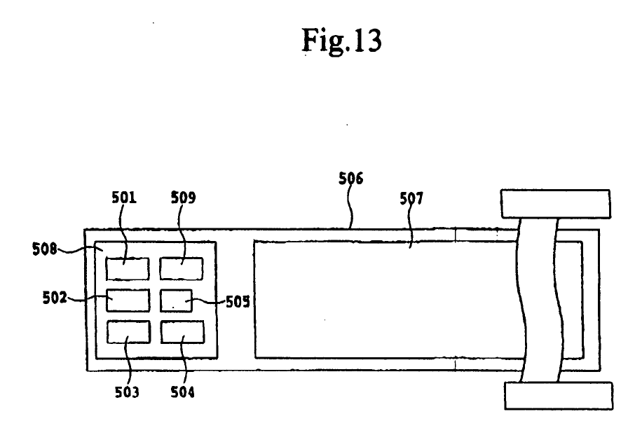

FIG. 13 schematically shows more concrete examples of the liquid crystal control integrated circuits 303 and 407, as well as the photoreceiving circuits 305 and 408.

In FIG. 13, reference symbol 508 represents a photoreceiving circuit. The photoreceiving circuit 508 includes a photoreceiving element which receives an inquiry signal light (see FIG. 1) sent from the light response transmission unit 21 of the authentication device 20 and converts the inquiry signal light into an electric signal. The photoreceiving circuit 508 also includes the following circuits: a bias voltage generating circuit 501 which generates bias voltage to a photoreceiving element 509, a signal level adjusting circuit 502 which adjusts the level of the electric signal photoelectrically converted by the photoreceiving element 509, a signal buffer latch circuit 503 which latches, i.e., holds the electric signal, a noise removing circuit 505 which removes noise from a signal output from the photoreceiving element 509, and an operation control circuit 504 which controls the operation of the above-described constituent circuits.

Reference symbol 507 represents a liquid crystal control integrated circuit which controls the liquid crystal display 301 and 302 in FIG. 11.

Reference symbol 506 represents a liquid crystal control integrated circuit chip having the above circuits.

Although the liquid crystal control integrated circuit chip 506 is provided at one end with the photoreceiving circuit 508 in FIG. 13, the photoreceiving circuit 508 may be disposed on a central portion of the chip or on a plurality of locations such as both ends of the chip.

It is sufficient that a photoreceiving device of the photoreceiving element 509 can convert the incident light into an electric signal. Therefore, as the photoreceiving device, it is possible to use a photodetector such as a photodiode and a phototransistor which has a PN junction. For faster operation, it is also possible to use a p-i-n photodiode and an avalanche photodiode. It is also possible to use a photoconductive element whose resistance value is changed when light enters therein, and a photovoltaic element such as a so-called solar battery which generates voltage when light enters therein.

In a so-called TFT liquid crystal, an active element such as an FET is disposed on the liquid crystal screen Therefore, if photoreceiving elements are integrated on a portion of the liquid crystal screen as will be described later, the photoreceiving element can be disposed on the liquid crystal display not on the liquid crystal control integrated circuit chip as in the examples shown in FIGS. 11 and 13. Here, all elements which receive light and converts the same into an electric signal are called photoreceiving elements.

The operation of the photoreceiving circuit 508 will be explained. First, bias voltage having appropriate value required for operating the photoreceiving element 509 is supplied from the bias voltage generating circuit 501 to the photoreceiving element 509. If the photoreceiving element does not require bias voltage, the bias voltage generating circuit 501 can be omitted.

An electric signal generated in the photoreceiving element 50 when the inquiry signal light (see FIG. 1) is output from the authentication device 20 passes through the noise removing circuit 505, and voltage and time width of the electric signal is adjusted so that the digital signal processing can be carried out in the signal level adjusting circuit 502. This digital signal is temporarily stored in the signal buffer latch circuit 503, and is input as an inquiry signal from the authentication device 20 to the processor 403 shown in FIG. 12. The above operation is controlled by the operation control circuit 504. The controlling operation control circuit 504 use a processor in another chip rather being integrated with the photoreceiving element.

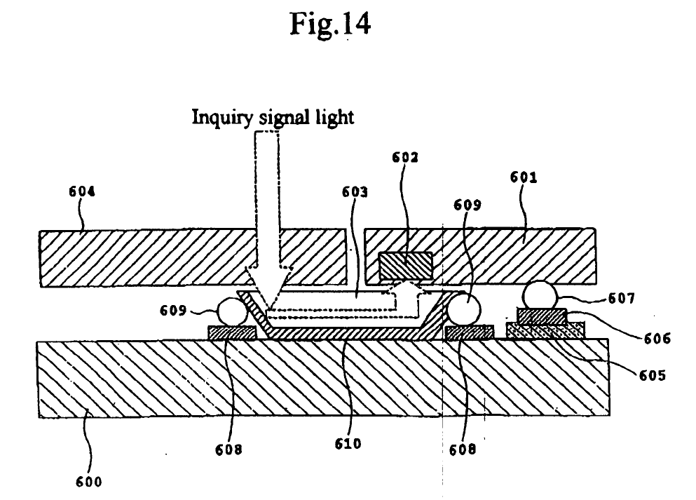

FIG. 14 shows a cross section of one example of a mount state of the liquid crystal panel and the liquid crystal control integrated circuit chip 506 on which the photoreceiving circuit 508 is integrated.

On a liquid crystal panel 600, there are disposed are a liquid crystal control integrated circuit chip 601 having photoreceiving function and on which a photoreceiving element 602 is integrated, an optical waveguide element 603 and a lens array 604. The lens array 604 is provided for increasing the strength of the light incident on the photoreceiving element 602 and for providing the incident light in different directions, i.e., predetermined emission angles.

An inquiry signal light (see FIG. 1) from the light response transmission unit 21 of the authentication device 20 enters the optical waveguide element 603 from the lens array 604, the inquiry signal light is reflected in the optical waveguide, and the proceeding direction is changed, and the inquiry signal light is introduced into the photoreceiving element 602. The optical path direction is changed in the optical waveguide element 603 because the liquid crystal control integrated circuit chip 601 is disposed over the liquid crystal panel 600, i.e., toward the incident light.

A chip-on glass (COG) technique can be used for this disposition. More specifically, it is possible to use a ball type surface mounting system such as P-BGA, P-FBGA, T-BGAFC-BGA, FP-BGA and the like, and lead type surface mounting system such as gull-wing lead type SOP, SSOP, TSSOP, TSOP1, TSOP2, QFP, fine pitch QFP, T/LQFP, J lead type SOJ and QFJ and the like. Package of various types can be used depending upon the number of wires required for the chip.

In FIG. 14, the ball type surface mounting system of BGA is employed. A transparent electrode 605 is formed on the liquid crystal panel 600, a soldering ball 607 is provided on the transparent electrode 605 through a mount pad 606, thereby supporting and mounting the liquid crystal control integrated circuit chip 401. The optical waveguide element 603 is disposed in a gap between the liquid crystal panel 600 and the liquid crystal control integrated circuit chip 601, and the optical waveguide element 603 is sandwiched and fixed from both lateral sides by means of mount pad and soldering 609. At that time, for example, in the case of a 225 pin BGA in which soldering paste of 150 μm is applied on the mount pad 605 and soldering ball 606 of 0.6 mm±0.1 mm is used, the height thereof after reflow is about 350 to 400 microns. Therefore, in this case, it is necessary that the thickness of the optical waveguide element 603 be about 300 microns.

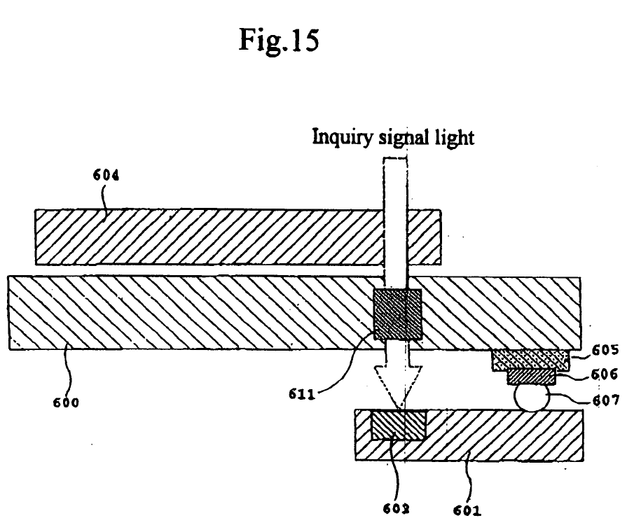

FIG. 15 shows another mounting example of the liquid crystal control integrated circuit chip 601 and the liquid crystal panel 600.

In FIG. 15, the liquid crystal control integrated circuit 601 is disposed on the back surface of the liquid crystal panel 600, and an incident inquiry signal light is introduced into the chip from the lens array 604 through the liquid crystal panel 600. According to this example, the optical waveguide element 603 (see FIG. 14) becomes unnecessary. In this case, the incident signal is turned ON and OFF by the pixel of the liquid crystal panel 600. In this way, an incident light strength adjustment function closing the shutter of a liquid crystal element when signal reception is not desired or limiting the input of light is provided. This incident light strength may be controlled using one pixel or two or more pixels. When two or more pixels are used, it is possible not only to adjust the light strength, but also to adjust the incident light strength according to the incident direction of light using the lens array 604 in cooperation. In FIG. 15, reference symbol 611 represents an incident light strength control pixel.

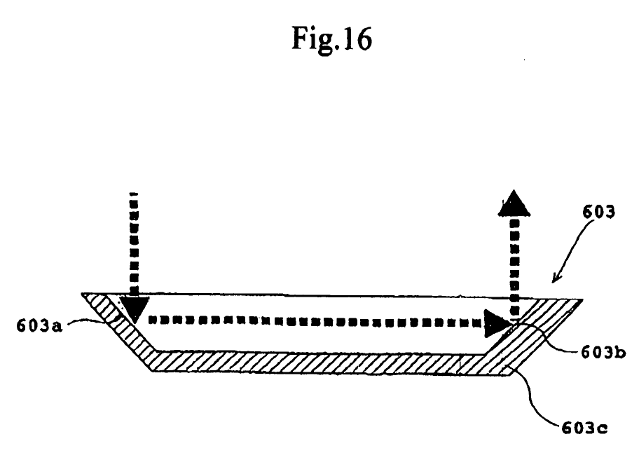

FIG. 16 schematically shows a more concrete structure of the optical waveguide element 603 shown in FIG. 14.

In order to allow the inquiry signal light sent from above (or front) to change its direction to the upward direction again and to enter the photoreceiving element 602, the optical waveguide element 603 includes two reflecting mirrors 603a and 603b each having a mirror of 45°. The reflecting mirrors 603a and 603b are opposed to each other and located on opposite sides in the optical waveguide as incident mirror and reflection mirror. A hack surface of the optical waveguide element 603 is covered with a metal film 603c. The metal film 603c is provided for increasing a reflection coefficient of the back surface of the optical waveguide element 603 (called reflection function), and for block out light from the liquid crystal panel 600, noise light signals (shielding function). The metal film 603c also plays a role as a soldering mount pad on the side of the optical waveguide when it is fixed to the liquid crystal panel 600. When the optical waveguide element 603 is fixed using adhesive or tackiness agent, it does not have this third role.

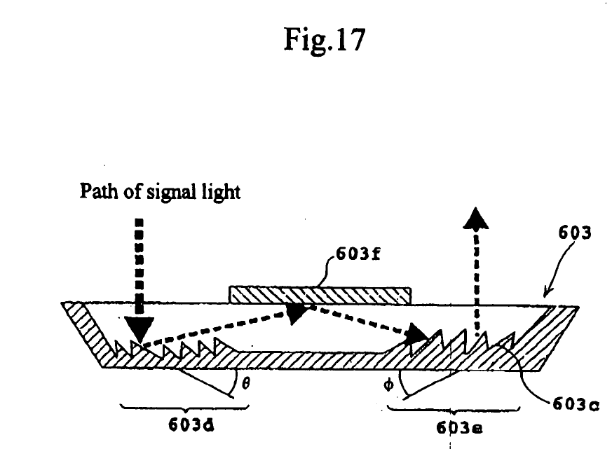

FIG. 17 shows another embodiment of the optical waveguide element 603.

When sufficient thickness of the optical waveguide element 603 can not be secured, this sometimes causes the reflecting mirrors 603a and 603b to have insufficient areas. In such a case, reflecting portions 603d and 603e are provided with a plurality of projections of triangular cross section on the inside surface of the back or the optical waveguide element 603 as shown in FIG. 17. The projections have angles θ and φ of less than 45°. Thereby, incident light can be introduced into the photoreceiving element 602 with high efficiency.

More specifically, in FIG. 17, the first reflecting portion 603d is provided on the inside surface of the back of t the optical waveguide element 603. The first reflecting portion 603d includes the plurality of projections whose angle θ is less than 45° and whose cross section is of triangular. A reflecting film 603f is provided on the front surface of the optical waveguide element 603 for reflecting the reflection light from the first reflecting portion 603d to change its direction. The second reflecting portion 603e is provided on the inside of the wave guide, the reflecting side of the optical waveguide element 603, and has a plurality of projections whose angle φ is less than 45°. According to this structure, light-collecting effect is increased by the reflection of the reflecting film 603f, and as compared with a case where the reflecting mirrors 603a and 603b of 45° shown in FIG. 16 are provided, and light can enter the photoreceiving element 601 (see FIG. 14) more effectively.

The reflecting film 603f can be formed by deposition of metal or dielectric material. If the photoreceiving element 602 can obtain sufficient incident light without a reflecting film, the reflecting film 603f can be omitted of course.

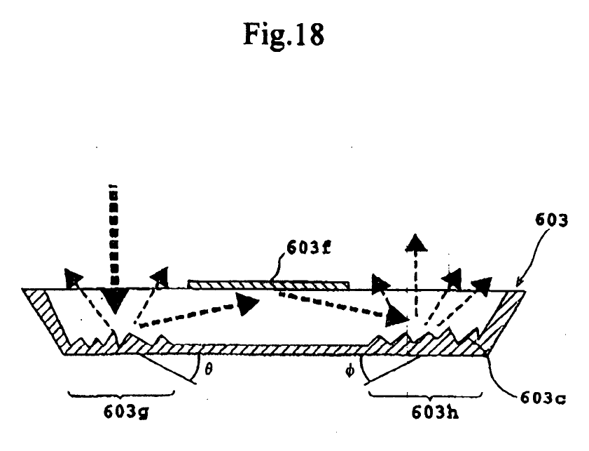

FIG. 18 shows another embodiment of the optical waveguide element 603.

As shown in FIG. 18, a portion of diffracted light can be introduced into the photoreceiving element 602 by diffracting light by regular or irregular diffraction grating projections and depressions on the back surface in the optical waveguide of the optical waveguide element 603. In this case, if high efficiency is not required, the angle θ or φ need not be less than 45°. In FIG. 18, the reflecting film 603f is used as above, and the first reflecting portion 603g on the incident side and the second reflecting 603h on the reflection side have diffracting projections and depressions.

A preferable material for making the optical waveguide element 603 is glass or thermal resistant transparent high polymer material capable of withstanding soldering temperature of the liquid crystal control integrated circuit chip 601 (see FIG. 14).

Although the photoreceiving element 602 is mounted on the liquid crystal control integrated circuit chip 603 in each of the mounting examples, the same effect can be obtained even if photoreceiving elements are integrated in the liquid crystal display such as a TFT liquid crystal.

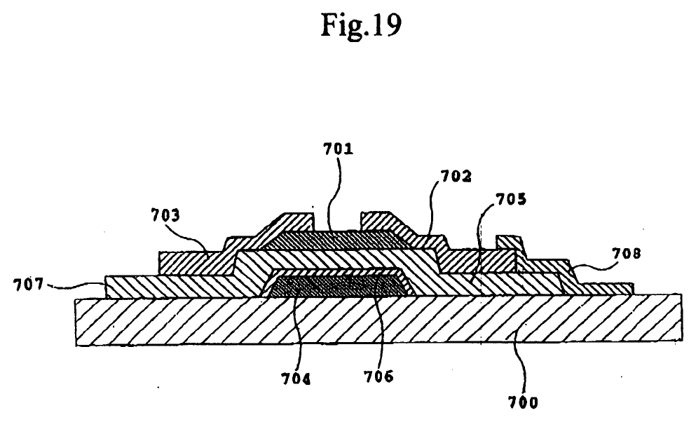

FIG. 19 shows one example of a liquid crystal driving TFT. In FIG. 19, reference symbol 700 represents a liquid crystal panel glass, reference symbol 701 represents a semiconductor, reference symbol 702 represents a drain electrode, reference symbol 703 represents a source electrode, reference symbol 704 represents a gate electrode, reference symbol 705 represents a gate insulator, reference symbol 706 represents a metal oxide film, reference symbol 707 represents a metal film, and reference symbol 708 represents a liquid crystal driving electrode. Examples of the semiconductor 701 are amorphous silicon, polysilicon, monocrystal silicon, and monocrystalized silicon.

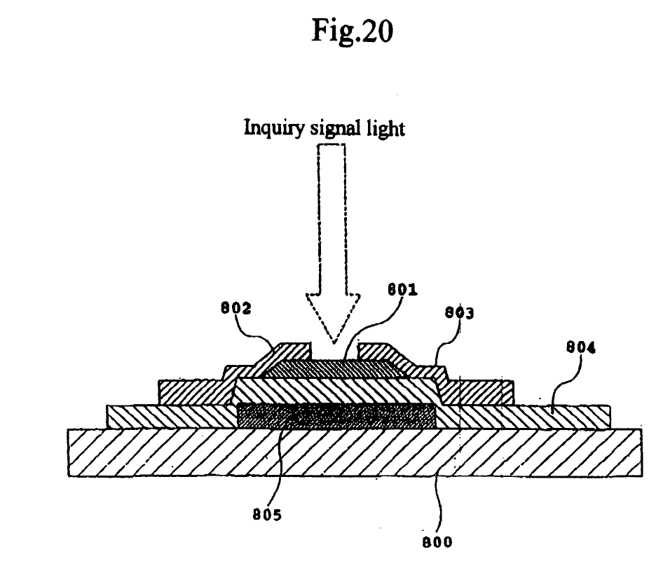

However, since the TFT of this type is an MOS-FET, it cannot be used as a photoreceiving element as it is. However, if an MSM (metal-semiconductor-metal) structure shown in FIG. 20 is formed, the MOS-FET can be a photoreceiving element.

In FIG. 20, reference symbol 800 represents a liquid crystal panel glass, reference symbol 801 represents a semiconductor, reference symbol 802 represents a first electrode, reference symbol 803 represents a second electrode, reference symbol 804 represents an insulator, and reference symbol 805 represents a shielding reflection layer.

The semiconductor 801 is the photoreceiving element. Below the semiconductor 801 is provided the shielding reflection layer 805. The shielding reflection layer 805 prevents light from entering from the liquid crystal panel back surface, reflects light which could not be absorbed by the semiconductor 801, increasing the photoelectric conversion efficiency. The same metal as that used for the gate electrode (704 in FIG. 19), e.g., tantalum can be used for the shielding reflection layer 805.

The same material as that of the gate insulating layer (705 in FIG. 19), e.g., silicon nitride and SiO2 can be used for the insulator 804.

If a signal light enters in a state in which bias voltage is applied between the first electrode 801 and the second electrode 802, an electron-hole pair is generated by photon in the semiconductor 801, and continuity is established between both the electrodes and current flows. Therefore, if the first electrode 801 and the second electrode 802 are respectively connected to circuits for selecting the pixels, the light signals incident upon each individual element can be determined.

The photoreceiving element is not limited to this MSM structure, and various photoreceiving element structure such as pn or p-i-n structure can be used.

Like the liquid crystal driving transistor, examples of semiconductor for the photoreceiving element are amorphous silicon, polysilicon, monocrystal silicon, and monocrystalized silicon.

In order to enhance the sensitivity of the photoreceiving element, size and volume of the semiconductor of the photoreceiving region may be increased or doping amount may be changed. In this case, the size becomes different from the element size of semiconductor for driving the liquid crystal pixel. If the photoreceiving elements are formed near every pixel of the high precision image display, the signal lines are increased and the fill factor of the liquid crystal pixel is reduced. This is tot preferable in general. However, if the photoreceiving element is disposed near the character display (e.g., 302 in FIG. 11) or the liquid crystal panel (e.g., 300 in FIG. 11), a liquid crystal display having photoreceiving element can be realized with sufficient sensitivity and performance.

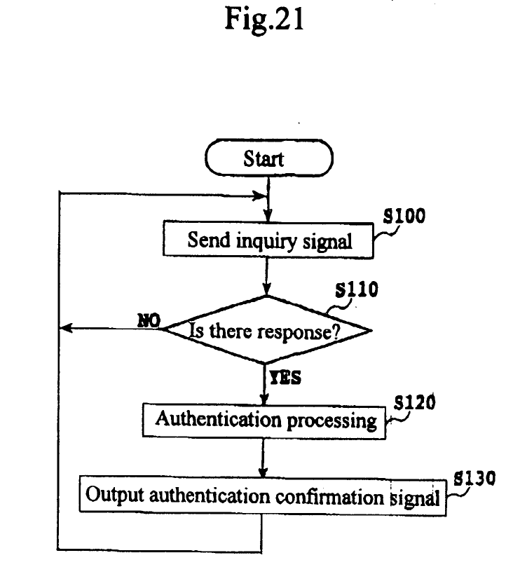

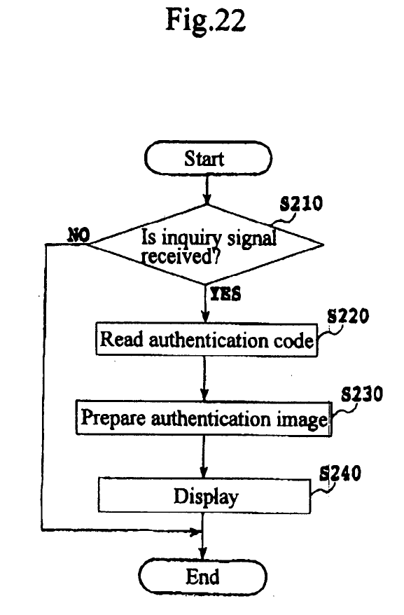

The operation of the authentication system shown in FIG. 1 having the above-explained structure will be explained with reference to FIGS. 21 and 22. FIG. 21 shows the processing of the control program executed by the CPU in the control device 23 of the authentication device 20. FIG. 22 shows the processing of the control program executed by the CPU (processor 403 in FIG. 12) in the emission angle-dependent light emitting device 10.

A inquiry signal is sent from the light response transmission unit 21 of the authentication device 20 to a emission angle-dependent light emitting device 10 of a person who requires authentication (step S100 in FIG. 21). Low amplitude micro waves may be used for this signal, but a light signal capable of concealing signals well is used in terms of security.

The emission angle-dependent light emitting device 10 which has detected (e g., through photoreceiving circuits 305, 408 in FIGS. 11 and 12) this inquiry signal (step S210 in FIG. 22) reads color data to be used for the authentication and its position and image (step S210 to step S220 in FIG. 22) from an internal memory (e.g., computation memory 402), prepares an authentication image in which the authentication information is incorporated, and stores it in an internal memory (e.g., display memory 404 in FIG. 12). Then, the prepared authentication image is displayed on the liquid crystal panel (e.g., 100 in FIG. 2) (step S240 in FIG. 22). With this, light of the authentication image, i.e., a scattered light pattern, that is, one with different parts emitted in different angles, is output from the lens array (e.g., 101 in FIG. 2) on the liquid crystal panel (liquid crystal display 301 for displaying image of the liquid crystal panel 300 in FIG. 11 for example).

If the emission angle-dependent light detector 22 (e.g., photoreceiver array 200 in FIGS. 5 and 6, and the image sensor 204 and the spherical convex lenses 205 and 206 in FIGS. 8 to 10) receives the light (step S110 in FIG. 21), the control device 23 extracts color data at a plurality of specific image positions in the image data obtained by photoelectrical conversion, and compares the same with the predetermined color data, thereby carrying out the authentication processing (CPU in the control device 23) (step S120 in FIG. 21).

Lastly, the CPU of the control device 23 outputs whether there is a match of authentication images to the devices 30, an authentication confirmation signal. If this signal indicates that there is an authentication match, any of the various devices 30 which receives it can start being driven or operated (including opening of a door and reception of input of a personal computer).

The authentication processing is carried out by checking different or same challenge and response pattern until the authentication match can be obtained. This pattern includes both a emission pattern having a specific angle and a time-series signal. If authentication is confirmed, the user is permitted to access the device 30 which requires security clearance.

[Another Structure of the Emission Angle-Dependent Light Emitting Device]

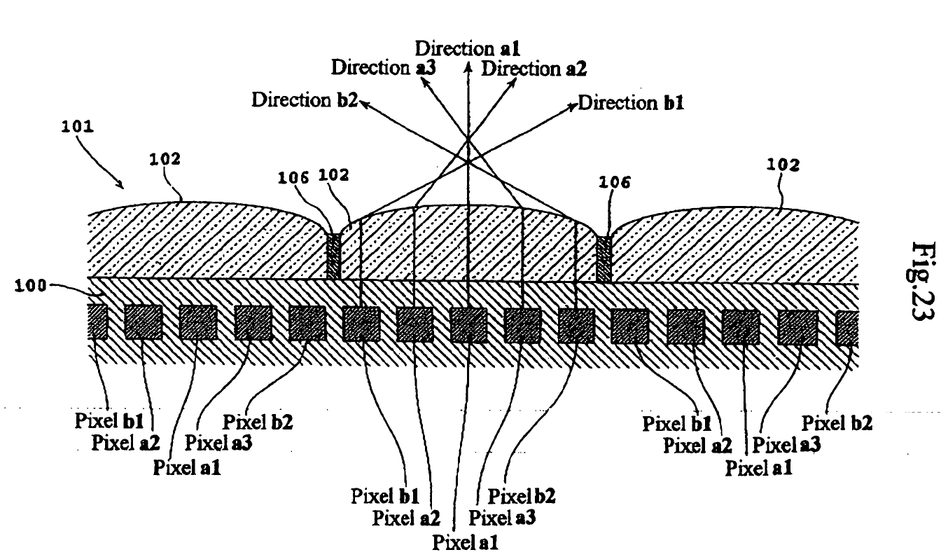

FIG. 23 shows another structure of the emission angle-dependent light emitting device.

In FIG. 23, pixels a1 are disposed directly below centers of the lenses 102 constituting the lens array 101, for being displayed directly in front of the screen (direction a1). From these positions, pixels a2, a3, b1, b2 are arranged in this order sideway for displaying directions a2, a3, b1 and b2 respectively. Then pixels a2, a3, b1 and b1 can also be used for authentication using a specific-angle image.

If each pixel emitted from each lens 102 is emitted with the same pattern, it can be used also for enlarging the viewing angle that can be observed. Conversely, in order to prevent an adjacent observer from peeping at the screen, only those pixels a1 which are emitted in a particular direction carry information e.g. if to be emitted directly in front, only the pixels directly below the centers of the lenses are caused to emit so that information can be concealed while being displayed.

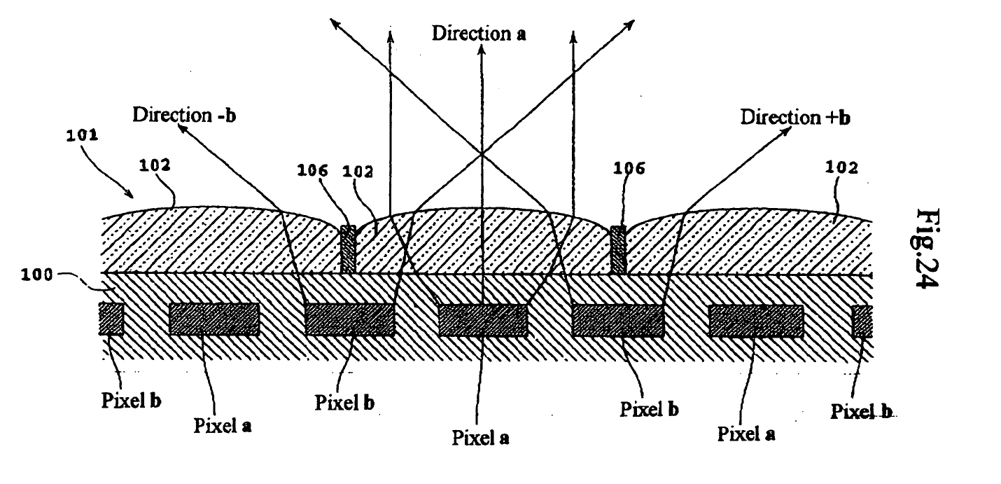

FIG. 24 shows another structure of the emission angle-dependent light emitting device.

In FIG. 24, pixels a are disposed directly below centers of the lenses 102 constituting the lens array 101, for being displayed directly in front of the screen (direction a). Pixels b for authentication are disposed at locations between adjacent lenses, and the light shielding layer 106 is disposed between the peripheries of adjacent lenses. In this case, if the screen is viewed from front, the pixels a can be seen, and the light from the pixels b is divided into emissions in direction +b and direction −b. When the photoreceiving element of the authentication device 20 receives light output only in a specified direction, the strength in the direction +b and the strength in the direction −b are the same, but when the photoreceiving element receives light only in a specific direction and in a specific position, or when the boundary between the lenses is not located on the center of the pixel b due to a result of production, the strengths are different. It is also possible to utilize this heterogeneity of strengths as a key of authentication of peculiar difference of individuals.

### ANOTHER EMBODIMENT

(1) A hologram pattern is displayed on the liquid crystal panel itself, and pattern which depends on a desired angle can be emitted. In this case, the optical system (lens array 101 in FIGS. 23, 2, 3, and 24) and the image on the side of the emission angle-dependent light emitting device 10 may be formed into a preferable style in correspondence with the hologram pattern. When it is unnecessary to output the hologram pattern, a graphic pattern having no hologram effect may be displayed. When it is desired to allow a person who watches the screen to recognize an image displayed on the liquid crystal panel, the hologram is preferable. When it is desired not to allow a person who watches the screen to recognize what is displayed, the graphic pattern is preferable.

(2) The authentication screen may vary the contents of images in a time series. The authentication image or incorporated authentication information may of course be varied in accordance with a person to be authenticated.

(3) Although the two-way communication is carried out between the authentication device 20 and the emission angle-dependent light emitting device 10 in the embodiment shown in FIG. 1, the emission angle-dependent light emitting device 10 of course need only carry out one-way communication.

(4) The embodiments can of course be applied to electronic systems for various other devices requiring authentications in addition to a door or a personal computer.

(5) A communication method other than that using light, i.e., radio wave or a cable, can be employed for communication between the light response transmission unit 21 and the emission angle-dependent light emitting device 10 as the inquiry means.

(6) As the emission angle-dependent light emitting device 10, it is possible to use existing electronics, e.g., electronics having display (especially liquid crystal display) such as cellular phones or portable terminals and the like. In this case, optical system means for scattering the display image may be detachably attached, and image in which authentication information is incorporated may be output when authentication is carried out.

(7) Contents of image in which authentication information is incorporated may be patterns, pictures, illustrations, figures, characters and the like. It is unnecessary to fix the image, and images may be changed in time series.

(8) If light energy of the pattern displayed by the light response transmission unit 21 is utilized, transmission of response signal, i.e., information can be sent to the emission angle-dependent light detector 22 without using using the emission angle-dependent light emitting device's own radio waves or light signal transmission means, or display means of backlit liquid crystal image. With this, it is possible to reduce radio wave emission to outside from the emission angle-dependent light emitting device 10 at the time of authentication, security is further enhanced, and electric consumption of the information terminal body can be reduced.

### INDUSTRIAL APPLICABILITY

As explained above, the present invention provides an authentication system, a light emitting device, an authentication device and an authentication method capable of carrying out authentication with good balance between excellent authentication accuracy and convenience using a totally new technique utilizing angle dependency distribution rather than authentication using merely one dimension or two dimension image.

1. An authentication system comprising:
a light emitting device having
display means for displaying an image in which authentication information is incorporated, and
first optical system means for diffracting light of the displayed image at a predetermined angle for each pixel; and
an authentication device having
second optical system means for collecting the light of the image diffracted by the light emitting device,
photoelectric converting means which carries out photoelectric conversion of the collected image, and
control means which carries out authentication using the converted image.

2. The authentication system according to claim 1, wherein the display means and the first optical system means are arranged so that in an image which is displayed by the display means, the image corresponding to the authentication information is diffracted and image other than the authentication information is emitted in a direction substantially perpendicular to a display screen of the display means.

3. The authentication system according to claim 1, wherein the image is displayed from the light emitting device in accordance with to an inquiry signal from the authentication device.

4. The authentication system according to claim 1, wherein the first optical system means and the second optical system means are lens arrays which utilize a one dimensional light distribution.

5. The authentication system according to claim 1, wherein the first optical system means and the second optical system means are lens arrays which utilize a two dimensional light distribution.

6. The authentication system according to claim 1, wherein the image is a hologram pattern.

7. The authentication system according to claim 1, wherein the image is a graphic pattern which does not exhibit hologram effect.

8. The authentication system according to claim 1, wherein the first optical system means is a lens array comprising a plurality of lenses, and gaps are provided between the lenses.

9. A light emitting device comprising:
display means for displaying an image in which authentication information is incorporated; and
optical system means fur diffracting light of the displayed image at a predetermined angle for each pixel.

10. The light emitting device according to claim 9, wherein the display means and the optical system means are arranged so that in the image which is displayed by the display means, the image corresponding to the authentication information is diffracted and the image other than authentication information is emitted in a direction substantially perpendicular to a display screen of the display means.

11. The light emitting device according to claim 9, wherein the image is displayed from the display means in accordance with an inquiry signal from an outside device.

12. The light emitting device according to claim 9, wherein the optical system means is a lens array which utilizes one dimensional light distribution.

13. The light emitting device according to claim 9, wherein the optical system means is a lens array which utilizes two dimensional light distribution.

14. The light emitting device according to claim 9, wherein the image is a hologram pattern.

15. The light emitting device according to claim 9, wherein the image is a graphic pattern which does not exhibit hologram effect.

16. The light emitting device according to claim 9, wherein the optical system means is a lens array comprising a plurality of lenses, and gaps are provided between the lenses.

17. An authentication device comprising:
optical system means for collecting light of an image scattered at a predetermined angle by an outside device;
photoelectric converting means which carries out photoelectric conversion of the collected image; and
control means which carries out authentication using the converted image.

18. The authentication device according to claim 17, wherein an image corresponding to authentication information in the image is diffracted and an image other than the authentication information is not diffracted.

19. The authentication device according to claim 17, wherein an inquiry is made for requesting the outside device to output the image.

20. The authentication device according to claim 17, wherein the optical system means is a lens array which utilizes a one dimensional light distribution.

21. The authentication device according to claim 17, wherein the optical system means is a lens array which utilizes a two dimensional light distribution.

22. The authentication device according to claim 17, wherein the image is a hologram pattern.

23. The authentication device according to claim 17, wherein the image is a graphic pattern which does not exhibit hologram effect.

24. The authentication device according to claim 17, wherein the outside device has an optical system means for diffracting light, said optical system means is a lens array comprising a plurality of lenses, and gaps are provided between the lenses.

25. An authentication method comprising the steps of:
displaying, from display means, an image in which authentication information is incorporated,
diffracting light of the displayed image at a predetermined angle for each pixel by first optical system means,
collecting, by second optical system means, light of the image diffracted by the first optical system means,
carrying out photoelectric conversion of the collected image by photoelectric converting means, and
carries out authentication by control means using the converted image.

26. The authentication method according to claim 25, wherein the display means and the first optical system means are arranged so that in the image which is displayed by the display means, the image corresponding to the authentication information is diffracted and the image other than authentication information is emitted in a direction substantially perpendicular to a display screen of the display means.

27. The authentication method according to claim 25, wherein the image is displayed from the display means in response to an inquiry.

28. The authentication method according to claim 25, wherein the first optical system means and the second optical system means are lens arrays which utilize a one dimensional light distribution.

29. The authentication method according to claim 25, wherein the first optical system means and the second optical system means are lens arrays which utilize a two dimensional light distribution.

30. The authentication method according to claim 25, wherein the image is a hologram pattern.

31. The authentication method according to claim 25, wherein the image is a graphic pattern which does not exhibit a hologram effect.

32. The authentication method according to claim 25, wherein the first optical system means is a lens array comprising a plurality of lenses, and gaps are provided between the lenses.
